(19) United States
(12) Patent Application Publication
(10) Pub. No.: US 2022/0238989 A1
(43) Pub. Date: Jul. 28, 2022

(54) ANTENNA DESIGN OF INTERNET OF THINGS FOR SHARING SCOOTER

(71) Applicant: GRABTAXI HOLDINGS PTE. LTD., Singapore (SG)

(72) Inventors: Shiqian WANG, Shenzhen, Guangdong (CN); Guodong SONG, Shenzhen, Guangdong (CN); Runfa FAN, Shenzhen, Guangdong (CN); Zhixin YU, Beijing (CN)

(21) Appl. No.: 17/610,510

(22) PCT Filed: Aug. 26, 2019
(86) PCT No.: PCT/SG2019/050422

§ 371 Date: Nov. 11, 2021

(51) Int. Cl. H01Q 1/32; H01Q 1/24; H01Q 1/42

(52) U.S. Cl. CPC H01Q 1/3283; B62K 3/002; H01Q 1/421; H01Q 1/241

(57) ABSTRACT

In one aspect, a scooter is provided. The scooter may include a steering column. The scooter may include a rider-support-platform coupled to the steering column. The scooter may include an antenna attached to the steering column. The antenna may be configured to perform wireless communication. The antenna may have a first inclination angle relative to the steering column. In another aspect, a method of providing a scooter is provided. The method may include providing a steering column of the scooter. The method may include coupling a rider-support-platform to the steering column. The method may include attaching an antenna to the steering column.

FIG. 2

TECHNICAL FIELD

Various aspects of this disclosure generally relate to wireless communication, and more particularly, to an antenna design for scooter.

### BACKGROUND

The Internet of things (IoT) is the network of devices such as vehicles and home appliances that contain electronics, software, actuators, and connectivity which allows these things to connect, interact and exchange data. The IoT involves extending Internet connectivity beyond standard devices, such as desktops, laptops, smartphones and tablets, to any range of traditionally non-internet-enabled physical devices and everyday objects. Embedded with technology, these devices can communicate and interact over the Internet, and they can be remotely monitored and controlled.

Mobile device sharing is a transportation innovation that is growing rapidly across cities. It solves the “last mile” problem by providing users an alternative device at better estimated time of arrival (ETA) and price than cars in crowded cities, reduces carbon emission, and provides a smarter transportation network to cities around the world. The future of urban mobility is shared, seamless, smart and environmentally sustainable. Motorized scooters (also may be referred to as e-scooter) would be a good addition to the active mobility landscape, serving unmet demands in the first-mile-last-mile (FMLM) travel segment.

Traditional e-scooter sharing IoT solution has limitations on the IoT capabilities. For example, traditional Global Positioning System (GPS) antenna design is not suited for e-scooter IoT component. Comparing with bike, the e-scooter is a much smaller device. As a result, many e-scooters can be seen falling on the ground or against the wall at all angles in a very limited space. This causes major challenge to the traditional GPS Antenna's vertical or horizontal design. The GPS signal receiving performance is not good enough to meet regulatory requirements on device tracking or to satisfy an optimal user experience in locating the scooters.

### SUMMARY

The following presents a simplified summary in order to provide a basic understanding of various aspects of the disclosed invention. This summary is not an extensive overview of all contemplated aspects, and is intended to neither identify key or critical elements of all aspects nor delineate the scope of any or all aspects. The sole purpose is to present some concepts of one or more aspects in a simplified form as a prelude to the more detailed description that is presented later.

In one aspect of the disclosure, a scooter is provided. The scooter may include a steering column. The scooter may include a rider-support-platform coupled to the steering column. The scooter may include an antenna attached to the steering column. The antenna may be configured to perform wireless communication. The antenna may have a first inclination angle relative to the steering column.

In another aspect of the disclosure, a method of providing a scooter is provided. The method may include providing a steering column of the scooter. The method may include coupling a rider-support-platform to the steering column. The method may include attaching an antenna to the steering column. The antenna may be configured to perform wireless communication. The antenna may have a first inclination angle relative to the steering column.

In some embodiments, the scooter may be a motorized scooter. In some embodiments, the steering column may have a second inclination angle relative to the upper surface of the rider-support-platform. In some embodiments, the antenna may have a third inclination angle relative to the upper surface of the rider-support-platform when the scooter is being used. In some embodiments, the upper surface of the rider-support-platform may be substantially parallel to the horizontal plane when the scooter is being used. In some embodiments, the second inclination angle may be equal to the sum of the first inclination angle and the third inclination angle. In some embodiments, the third inclination angle may be in the range of 45 degrees to 60 degrees. In some embodiments, the antenna may have a fourth inclination angle relative to the horizontal plane when the scooter is placed (e.g., laid down) on the ground. In some embodiments, the fourth inclination angle may substantially equal to the first inclination angle. In some embodiments, the thickness of the antenna may be greater than a threshold.

To the accomplishment of the foregoing and related ends, the aspects disclosed include the features hereinafter fully described and particularly pointed out in the claims.

The following description and the annexed drawings set forth in detail illustrate certain features of the aspects of the disclosure. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a scooter.

FIG. 2 is a diagram illustrating a cross-sectional view of an example of antenna design for scooter.

FIG. 3 is a diagram illustrating an example of a scooter that is riding or stopping on the road.

FIG. 4 is a diagram illustrating an example of a scooter that is placed on the ground.

FIG. 5 is a flowchart of a method of providing a scooter.

### DETAILED DESCRIPTION

The detailed description set forth below in connection with the appended drawings is intended as a description of various possible configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of an antenna design for scooter will now be presented with reference to various apparatus and methods. The apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

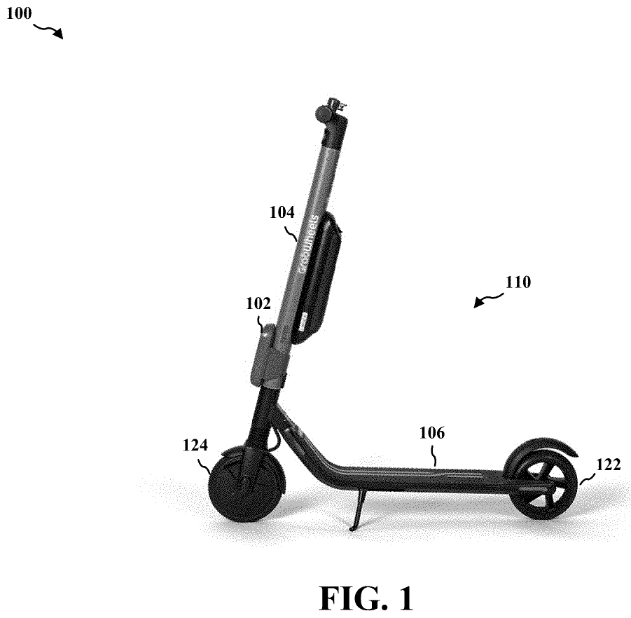

FIG. 1 is a diagram illustrating an example of a scooter 100. According to various embodiments, the scooter 100 may include a main body 110 including a rider-support-platform 106 and a steering column 104 coupled to the rider-support-platform 106. According to various embodiments, the rider-support-platform 106 may be configured to support a rider directly standing on top of the rider-support-platform 106. For example, the rider-support-platform 106 may be a deck of an electric kick scooter configured for a rider to stand on. According to various embodiments, the rider-support-platform 106 may be configured to support a rider via a seat structure on the rider-support-platform 106 on which the rider may be seated. According to various embodiments, the rider-support-platform 106 may be aligned horizontally with respect to the ground. According to various embodiments, the steering column 104 may be extending in upward directions with respect to the rider-support-platform 106. According to various embodiments, the steering column 104 may be substantially vertical or upright with respect to the rider-support-platform 106. According to various embodiments, the steering column 104 may be configured for the rider to steer the direction of movement of the scooter 100. According to various embodiments, the steering column 104 may be pivotably coupled to the rider-support-platform 106. According to various embodiments, the steering column 104 may include a handle that the rider may hold onto.

In some embodiments, the scooter 100 may be a motorized scooter equipped with an IoT communication module 102, which may be an external box attached to the steering column 104. The IoT communication module 102 may enable optimization of the operations or maintenance of the motorized scooter so that efficiency may be achieved. For example, the motorized scooter may be unlocked/locked by scanning the Quick Response (QR) code. The unlock time may be less than 5 seconds, and the success rate may be higher than 90%. In some embodiments, user riding data (e.g., when you ride, where you are riding, how long you ride, etc.) may be collected in real-time. In some embodiments, the real-time data of the motorized scooter (e.g., the speed, the power volume, how far has already ride, falling down on the ground or not, etc.) may be collected. In some embodiments, customized human-machine interface (e.g., unlock or lock reminder, alarm, etc.) may be provided to users.

In some embodiments, the IoT communication module 102 may serve to track the scooters' service status and location at any given time. The IoT communication module 102 also makes it possible to transmit commands to the scooters via cloud server. In addition, the IoT communication module 102 may contain an internal speaker for unlocking/locking indication and alerting the sensors for any abnormal activities detected (e.g., falling down, abnormal movement, etc.) to enhance operational efficiency.

In some embodiments, the design of the antenna of the IoT communication module 102 may be optimized for sharing scenario. In some embodiments, the electronics of the scooter 100 may be fail safe for electric failure and battery safety. The design of the scooter 100 may be focused on optimizing for user experience (e.g., unlock, lock) so user spends as little time interacting with the app as possible. The product may be designed specifically for situations of theft and sabotage, which is known issues in the shared device industry.

According to various embodiments, the scooter 100 may include a wheel arrangement supporting the main body 110. The wheel arrangement may include at least one front wheel 124 and at least one rear wheel 122. According to various embodiments, the wheel arrangement may be supporting the main body 110 in a manner such that the main body 110 is elevated above the ground. Accordingly, only the at least one front wheel 124 and the at least one rear wheel 122 may be in contact with the ground. Hence, the scooter 100 may be moved with respect to the ground via the rotation or turning of the at least one front wheel 124 and the at least one rear wheel 122. According to various embodiments, the at least one front wheel 124 may be configured to be steerable by the steering column 104. According to various embodiments, the at least one front wheel 124 may be coupled to the steering column 104. According to various embodiments, the steering column 104 may include a front wheel fork which holds the at least one front wheel 124.

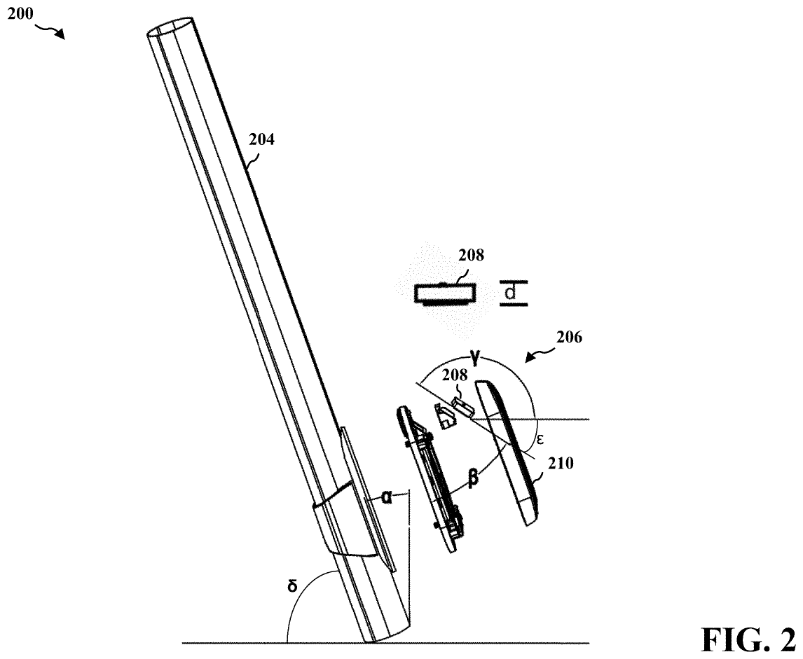

FIG. 2 is a diagram 200 illustrating a cross-sectional view of an example of antenna design for scooter. In the example, an IoT communication module 206 may be attached to a steering column 204 of a scooter. In some embodiments, the IoT communication module 206 may be the IoT communication module 102 described above with reference to FIG. 1. In some embodiments, the steering column 204 may be the steering column 104 described above with reference to FIG. 1. In some embodiments, the steering column 204 may have an inclination angle a relative to a vertical axis when the scooter is being used (e.g., when rider is riding on the scooter). The steering column 204 may have an inclination angle 6 relative to the rider-support-platform of the scooter. The inclination angles a and 6 may be complementary angles, i.e., they add up to 90° . In some embodiments, the rider-support-platform may be substantially parallel to the ground or substantially parallel to the horizontal plane.

In some embodiments, the steering column 204 may be substantially vertical or upright with respect to the rider-support-platform. Thus, the inclination angle α may be small and the inclination angle δ may be close to 90° .

The IoT communication module 206 may include an antenna 208. The antenna 208 may be enclosed within a protective cover 210 of the IoT communication module 206. In some embodiments, the antenna 208 may be affixed in the IoT communication module 206 so that the antenna 208 has an inclination angle β relative to the steering column 204.

In some embodiments, the antenna 208 may have an inclination angle γ relative to the ground in front of the front wheel of the scooter when the scooter is being used (e.g., when rider is riding on the scooter). The antenna 208 may also have an inclination angle relative to the rider-support-platform of the scooter when the scooter is being used (e.g., when rider is riding on the scooter). The inclination angles γ and ε may be supplementary angles, i.e., they add up to 180° .

In some embodiments, the inclination angles α, β, ε may be complementary angels. In some embodiments, the sum of inclination angles α and β may equal to inclination angle γ minus 90° . In some embodiments, the sum of inclination angles β and ε may equal to inclination angle δ.

In some embodiments, the inclination angle γ may be in the range of 120° to 135° . Accordingly, the inclination angle ε may be in the range of 45° to 60° .

In some embodiments, the antenna 208 may have a thickness of d. The thickness of the antenna 208 may be increased to enhance the performance of the antenna 208. In some embodiments, the thickness of the antenna 208 may exceed a predetermined threshold (e.g., 2 mm, 3 mm, or 5 mm). Because of the antenna design, no matter which angle the scooter lays down on the ground or against on the wall, the IoT communication module may receive a good signal.

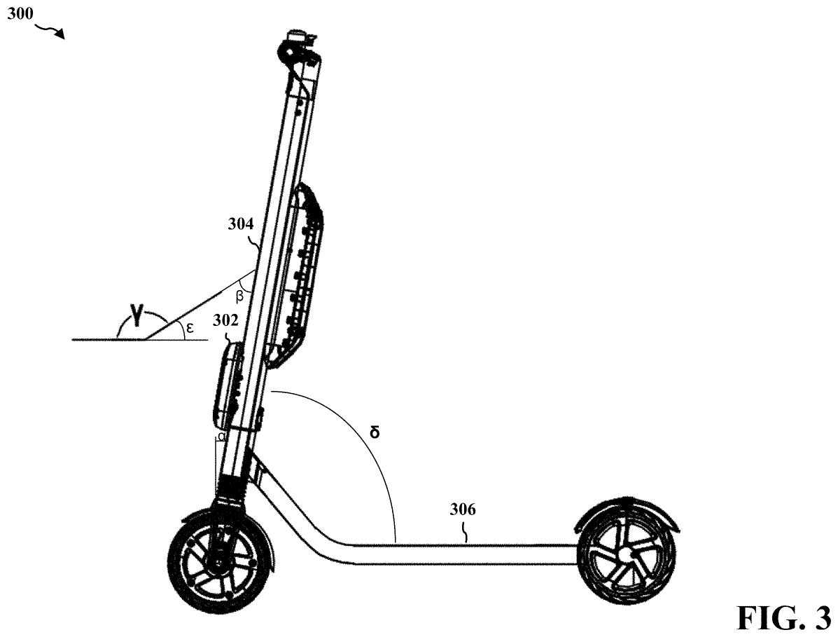

FIG. 3 is a diagram illustrating an example of a scooter 300 that is riding or stopping on the road. In the example, the scooter 300 may include a rider-support-platform 306 and a steering column 304 coupled to the rider-support-platform 306. In some embodiments, the scooter 300 may be a motorized scooter equipped with an IoT communication module 302, which may be an external box attached to the steering column 304.

In some embodiments, the scooter 300 may be the scooter 100 described above with reference to FIG. 1 or the scooter described above with reference to FIG. 2. In some embodiments, the IoT communication module 302 may be the IoT communication module 102 or 206 described above with reference to FIG. 1 or FIG. 2, respectively. In some embodiments, the steering column 304 may be the steering column 104 or 204 described above with reference to FIG. 1 or FIG. 2, respectively. The rider-support-platform 306 may be the rider-support-platform 106 described above with reference to FIG. 1.

In some embodiments, the steering column 304 may have an inclination angle α relative to a vertical axis when the scooter is being used (e.g., when rider is riding on the scooter). The steering column 304 may have an inclination angle δ relative to the rider-support-platform 306 of the scooter 300. The inclination angles α and δ may be complementary angles, i.e., they add up to 90° . In some embodiments, the rider-support-platform 306 may be substantially parallel to the ground or substantially parallel to the horizontal plane.

The IoT communication module 302 may include an antenna (not shown). In some embodiments, the antenna may be affixed in the IoT communication module 302 so that the antenna has an inclination angle β relative to the steering column 304.

In some embodiments, the antenna may have an inclination angle γ relative to the ground in front of the front wheel of the scooter 300 when the scooter is being used (e.g., when rider is riding on the scooter). The antenna may also have an inclination angle ε relative to the rider-support-platform 306 of the scooter 300 when the scooter is being used (e.g., when rider is riding on the scooter). The inclination angles γ and ε may be supplementary angles, i.e., they add up to 180° .

In some embodiments, the inclination angles α, β, ε may be complementary angels. In some embodiments, the sum of inclination angles α and β may equal to inclination angle γ minus 90° . In some embodiments, the sum of inclination angles β and ε may equal to inclination angle δ.

In some embodiments, the inclination angle γ may be in the range of 120° to 135° . Accordingly, the inclination angle ε may be in the range of 45° to 60° .

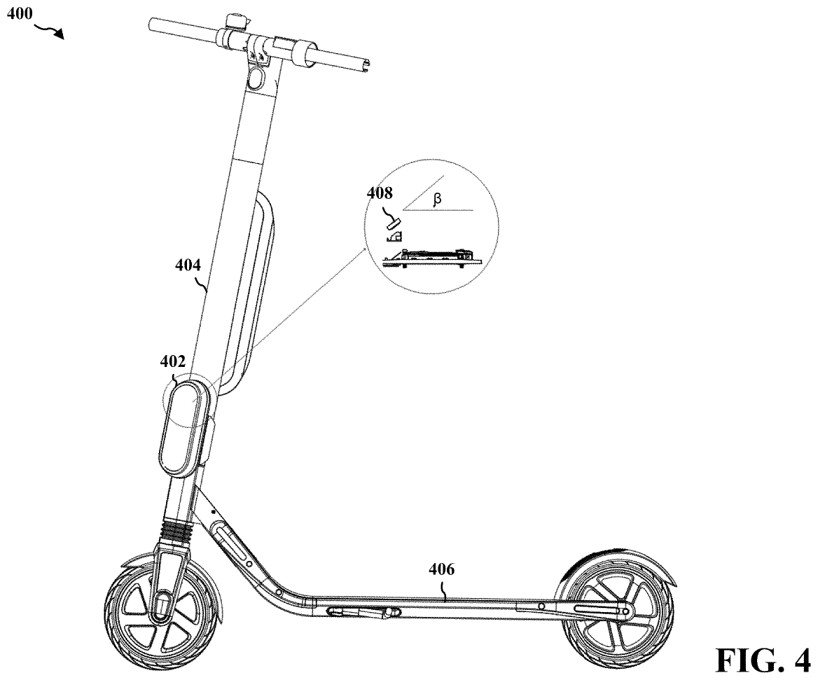

FIG. 4 is a diagram illustrating an example of a scooter 400 that is placed on the ground. In the example, the scooter 400 may include a rider-support-platform 406 and a steering column 404 coupled to the rider-support-platform 406. In some embodiments, the scooter 400 may be a motorized scooter equipped with an IoT communication module 402, which may be an external box attached to the steering column 404.

In some embodiments, the scooter 400 may be the scooter 100 described above with reference to FIG. 1, or the scooter described above with reference to FIG. 2, or the scooter 300 described above with reference to FIG. 3. In some embodiments, the IoT communication module 402 may be the IoT communication module 102, 206, or 302 described above with reference to FIG. 1, FIG. 2, or FIG. 3, respectively. In some embodiments, the steering column 404 may be the steering column 104, 204, or 304 described above with reference to FIG. 1, FIG. 2, or FIG. 3, respectively. The rider-support-platform 406 may be the rider-support-platform 106 or 306 described above with reference to FIG. 1 or FIG. 3, respectively.

The IoT communication module 402 may include an antenna 408. In some embodiments, the antenna 408 may be affixed in the IoT communication module 402 so that the antenna 408 has an inclination angle β relative to the steering column 404.

In some embodiments, the antenna 408 may have an inclination angle relative to the ground that substantially equals to the inclination angle β when the scooter 400 is placed on the ground. In some embodiments, the inclination angle β may be in the range of 30° to 40° .

A scooter may be placed in many different ways. For example, a scooter may be placed indoor or outdoor; a scooter may stand on the ground when running or stopping; a scooter may be laid down on the ground. With the antenna design described above with reference to FIGS. 2-4, no matter how the scooter is placed, the antenna may have an inclination angle relative to the ground so that the antenna is neither horizontally placed nor vertically placed. As a result, the antenna may establish high quality communication channel at all time.

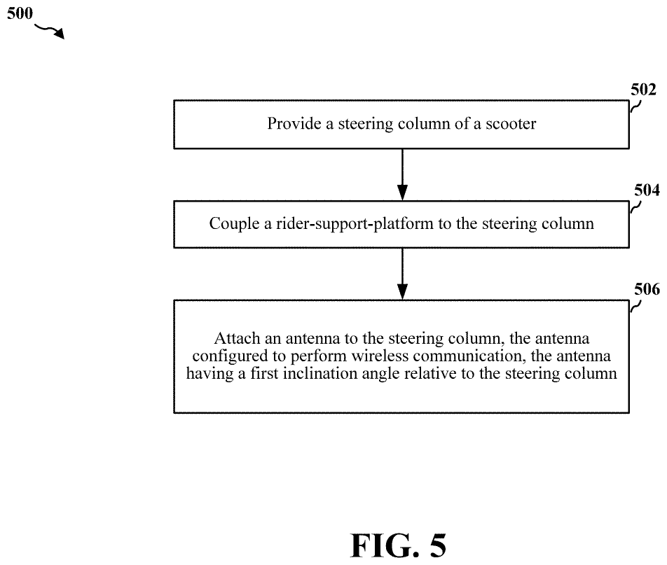

FIG. 5 is a flowchart 500 of a method of providing a scooter. In some embodiments, the scooter provided by this method may be the scooter described above with reference to FIGS. 1-4. In some embodiments, the scooter may be a motorized scooter. At 502, the method may include providing a steering column of the scooter.

At 504, the method may include coupling a rider-support-platform to the steering column. In some embodiments, the upper surface of the rider-support-platform may be substantially parallel to horizontal plane when the scooter is being used.

At 506, the method may include attaching an antenna to the steering column. The antenna may be configured to perform wireless communication. The antenna may have a first inclination angle relative to the steering column. In some embodiments, the thickness of the antenna may be greater than a threshold.

In some embodiments, the steering column may have a second inclination angle relative to the upper surface of the rider-support-platform. In some embodiments, the antenna may have a third inclination angle relative to the upper surface of the rider-support-platform when the scooter is being used. In some embodiments, the third inclination angle may be in the range of 45 degrees to 60 degrees. In some embodiments, the second inclination angle may be equal to the sum of the first inclination angle and the third inclination angle.

In some embodiments, the antenna may have a fourth inclination angle relative to the horizontal plane when the scooter is placed on the ground. In some embodiments, the fourth inclination angle may substantially equal to the first inclination angle.

In the following, various aspects of this disclosure will be illustrated:

Example 1 is a scooter. The scooter may include: a steering column; a rider-support-platform coupled to the steering column; and an antenna attached to the steering column. The antenna may be configured to perform wireless communication. The antenna may have a first inclination angle (e.g., β) relative to the steering column.

In Example 2, the subject matter of Example 1 may optionally include that the scooter may be a motorized scooter.

In Example 3, the subject matter of Example 1 or 2 may optionally include that the steering column may have a second inclination angle (e.g., δ) relative to the upper surface of the rider-support-platform.

In Example 4, the subject matter of Example 3 may optionally include that the antenna may have a third inclination angle (e.g., ε) relative to the upper surface of the rider-support-platform when the scooter is being used.

In Example 5, the subject matter of Example 3 or 4 may optionally include that the upper surface of the rider-support-platform may be substantially parallel to the horizontal plane when the scooter is being used.

In Example 6, the subject matter of any one of Examples 4 to 5 may optionally include that the second inclination angle (e.g., δ) may equal to the sum of the first inclination angle (e.g., β) and the third inclination angle (e.g., ε).

In Example 7, the subject matter of any one of Examples 4 to 6 may optionally include that the third inclination angle (e.g., ε) may be in the range of 45 degrees to 60 degrees.

In Example 8, the subject matter of any one of Examples 4 to 7 may optionally include that the antenna may have a fourth inclination angle (e.g., β) relative to horizontal plane when the scooter is placed on the ground.

In Example 9, the subject matter of Example 8 may optionally include that the fourth inclination angle may substantially equal to the first inclination angle.

In Example 10, the subject matter of any one of Examples 1 to 9 may optionally include that the thickness of the antenna may be greater than a threshold.

Example 11 is a method of providing a scooter. The method may include: providing a steering column; coupling a rider-support-platform to the steering column; and attaching an antenna to the steering column. The antenna may be configured to perform wireless communication. The antenna may have a first inclination angle (e.g., β) relative to the steering column.

In Example 12, the subject matter of Example 11 may optionally include that the scooter may be a motorized scooter.

In Example 13, the subject matter of Example 11 or 12 may optionally include that the steering column may have a second inclination angle (e.g., δ) relative to the upper surface of the rider-support-platform.

In Example 14, the subject matter of Example 13 may optionally include that the antenna may have a third inclination angle (e.g., ε) relative to the upper surface of the rider-support-platform when the scooter is being used.

In Example 15, the subject matter of Example 13 or 14 may optionally include that the upper surface of the rider-support-platform may be substantially parallel to the horizontal plane when the scooter is being used.

In Example 16, the subject matter of any one of Examples 14 to 15 may optionally include that the second inclination angle (e.g., δ) may equal to the sum of the first inclination angle (e.g., β) and the third inclination angle (e.g., ε).

In Example 17, the subject matter of any one of Examples 14 to 16 may optionally include that the third inclination angle (e.g., ε) may be in the range of 45 degrees to 60 degrees.

In Example 18, the subject matter of any one of Examples 14 to 17 may optionally include that the antenna may have a fourth inclination angle (e.g., β) relative to horizontal plane when the scooter is placed on the ground.

In Example 19, the subject matter of Example 18 may optionally include that the fourth inclination angle may substantially equal to the first inclination angle.

In Example 20, the subject matter of any one of Examples 11 to 19 may optionally include that the thickness of the antenna may be greater than a threshold.

A person skilled in the art will appreciate that the terminology used herein is for the purpose of describing various embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A scooter, comprising:
a steering column;
a rider-support-platform coupled to the steering column; and
an antenna attached to the steering column, the antenna configured to perform wireless communication, wherein the antenna has a first inclination angle relative to the steering column.

2. The scooter of claim 1, wherein the scooter is a motorized scooter.

3. The scooter of claim 1, wherein the steering column has a second inclination angle relative to a surface of the rider-support-platform.

4. The scooter of claim 3, wherein the antenna has a third inclination angle relative to the surface of the rider-support-platform when the scooter is being used.

5. The scooter of claim 3, wherein the surface of the rider-support-platform is substantially parallel to horizontal plane when the scooter is being used.

6. The scooter of claim 4, wherein the second inclination angle equals to a sum of the first inclination angle and the third inclination angle.

7. The scooter of claim 4, wherein the third inclination angle is in the range of 45 degrees to 60 degrees.

8. The scooter of claim 4, wherein the antenna has a fourth inclination angle relative to horizontal plane when the scooter is placed on the ground.

9. The scooter of claim 8, wherein the fourth inclination angle substantially equals to the first inclination angle.

10. The scooter of claim 1, wherein a thickness of the antenna is greater than a threshold.

11. A method of providing a scooter, the method comprising:
providing a steering column of the scooter;
coupling a rider-support-platform to the steering column; and
attaching an antenna to the steering column, the antenna configured to perform wireless communication, wherein the antenna has a first inclination angle relative to the steering column.

12. The method of claim 11, wherein the scooter is a motorized scooter.

13. The method of claim 11, wherein the steering column has a second inclination angle relative to a surface of the rider-support-platform.

14. The method of claim 13, wherein the antenna has a third inclination angle relative to the surface of the rider-support-platform when the scooter is being used.

15. The method of claim 13, wherein the surface of the rider-support-platform is substantially parallel to horizontal plane when the scooter is being used.

16. The method of claim 14, wherein the second inclination angle equals to a sum of the first inclination angle and the third inclination angle.

17. The method of claim 14, wherein the third inclination angle is in the range of 45 degrees to 60 degrees.

18. The method of claim 14, wherein the antenna has a fourth inclination angle relative to horizontal plane when the scooter is placed on the ground.

19. The method of claim 18, wherein the fourth inclination angle substantially equals to the first inclination angle.

20. The method of claim 11, wherein a thickness of the antenna is greater than a threshold.
